(19) United States
(12) Patent Application Publication
(10) Pub. No.: US 2006/0027115 A1
(43) Pub. Date: Feb. 9, 2006

(54) Method for operating a printing press

(75) Inventor: Michael Schonert, Augsburg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/194,235

(22) Filed: Aug. 1, 2005

(30) Foreign Application Priority Data
Aug. 6, 2004 (DE) 10 2004 038 298.0

(51) Int. Cl. B41F 33/00

(52) U.S. Cl. 101/484

(57) ABSTRACT

The invention relates to a method for operating a printing press, in particular an offset printing press, so as to control accumulation of printing material on at least one rubber blanket of a transfer cylinder. Damping solution onto a forme cylinder, which interacts with the transfer cylinder, is controlled so as to minimize the positive build-up and/or negative build-up of the printing material on the transfer cylinder.

### BACKGROUND OF THE INVENTION

1. Field of the Invention

The invention relates to a method for operating a printing press and to a printing unit carrying out the method.

2. Description of the Related Art

A printing apparatus of printing presses has a plurality of printing units, each of which comprises a transfer cylinder, a forme cylinder, an inking unit and a damping unit. Furthermore, printing units of this type can have impression cylinders, so that it is possible for one impression cylinder to interact with one or more transfer cylinders of different printing units.

Printing apparatuses which do not have any impression cylinders are also known to have the transfer cylinders of two printing units rolling on one another without impression cylinders. As a rule, rubber blankets are clamped on the transfer cylinders which, thus, are called blanket cylinders. Printing plates in turn, are clamped on the forme cylinders, for which reason the forme cylinders are also called printing-plate cylinders. The inking unit of a printing unit serves to apply printing ink onto the forme cylinder of the printing unit, whereas the damping unit serves to apply a damping solution onto the forme cylinder of the printing unit.

During printing, various components of the materials which are involved in printing are deposited on the transfer cylinder or on the rubber blanket which is positioned on the transfer cylinder. Depending on the type of these deposits, they are called “positive build-up” or “negative build-up” on the rubber blanket. In the case of positive build-up, constituents of the printing material and of the printing ink are deposited in the printing regions of the rubber blanket. In the event of negative build-up, deposits are produced in the non-printing regions of the rubber blanket. Both the positive build-up and negative build-up considerably impair the printed quality. For this reason, the rubber blanket has to be cleaned after a certain production time. These cleaning intervals interrupt the continuous printing process and cause a shut down of the printing press. As a result, the productivity of the printing press is impaired. In extreme cases, the rubber blanket can be destroyed by the above-mentioned deposits.

It is, therefore, an object of the present invention to provide a novel method for operating a printing press in a manner minimizing the positive and/or negative build up.

### SUMMARY OF THE INVENTION

The aforementioned problem is solved by controllably applying a damping solution onto a forme cylinder and further onto at least one printing plate so as to minimize the positive build-up and/or negative build-up.

For this purpose, the amount of damping solution is measured on the forme cylinder or on each printing plate which is arranged on the forme cylinder, a corresponding measured value being fed to a closed control loop as an actual value. This actual value is compared with a setpoint value in a control device, the control device regulating the supply of damping solution or the application of damping solution as a function of the deviation determined here between the setpoint value and the actual value in such a way that the actual value follows the setpoint value. As a result, undesirable deposits on the rubber blanket can be minimized. Thus, the application of damping solution is regulated in such a way that the applied damping solution does not have a negative effect on other parameters which are important for the printing quality, such as the ink density on the printing material.

According to one advantageous development of the present invention, an empirically determined setpoint value profile is predefined for the application of damping solution, as a function of which the application of damping solution is regulated. The empirically determined setpoint value profile is dependent on a printing-material property and/or on a printing-plate property, a printed quality which is to be attained, a print-job amount, a damping-solution property, and/or an ink coverage of the inking unit which interacts with the damping unit which is to be regulated.

Other objects and features of the present invention will become more apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a diagrammatic view of a printing unit according to the present invention; and

FIG. 2 shows a possible setpoint value profile of the method according to the present invention for operating a printing press.

### DETAILED DESCRIPTION OF THE PRESENTLY PREFERRED EMBODIMENTS

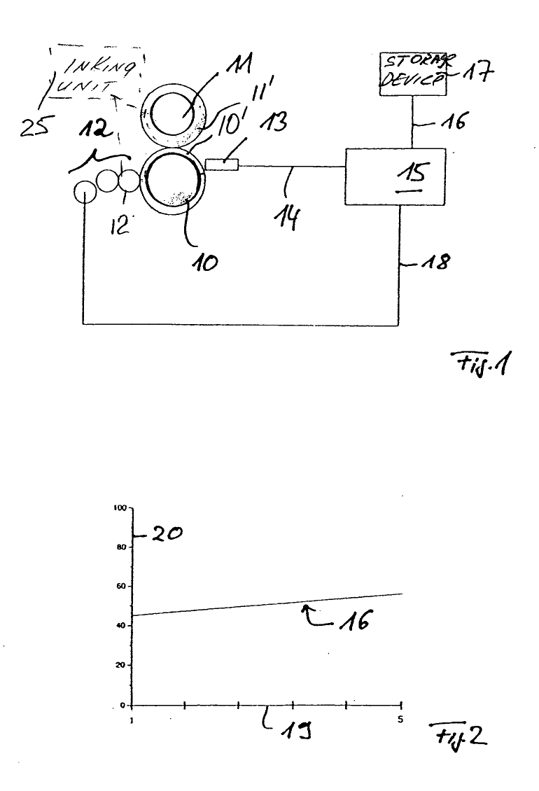

FIG. 1 shows a diagrammatic detail of a printing unit of a printing press in the region of a forme cylinder 10, of a transfer cylinder 11 which interacts with the forme cylinder 10, and in the region of a damping unit 12. At least one printing plate 10′ is clamped on the forme cylinder 10, for which reason the forme cylinder 10 is also called a printing-plate cylinder. At least one rubber blanket 11′ is clamped on the transfer cylinder 11, for which reason the transfer cylinder 11 is also called a blanket cylinder. A damping solution can be applied onto the printing plate of the forme cylinder 10 with the aid of the damping unit 12. In addition to the damping unit 12 the printing unit also comprises an inking unit 25 operative to supply printing ink onto the forme cylinder 12 or the corresponding printing plates.

In accordance with the present invention, the amount of damping solution applied on the printing plates of the forme cylinder 10 is measured with at least one sensor 13. A measured or actual value 14 of the amount of damping solution is fed to a control device 15. The control device 15 compares this actual value 14 with a setpoint value 16 which is provided in a storage device 17. The control device 15 determines a control deviation from the comparison between the actual value 14 and the setpoint value 16 and generates an actuating signal 18 enabling the damping unit 12 to regulate the application of damping solution onto the forme cylinder 10 on the basis of this control deviation. The regulation is effected in such a way that undesirable deposits on the forme cylinder are minimized which leading, thus, to a positive build-up or negative build-up on the or each rubber blanket.

It should be noted that one or more sensors 13 operates without contact, preferably as an optical sensor or as a capacitive sensor or a microwave sensor. Furthermore, it should be noted that the measurement of the application of damping solution on the forme cylinder does not have to be carried out by the measurement of the amount of damping solution on the forme cylinder, but rather the application of damping solution can also be measured at other positions within the damping unit, for example on a damping-solution applicator roll 12′ which applies the damping solution onto the forme cylinder.

In terms of the present invention, a setpoint value profile for the application of damping solution is predefined in the storage device 17 for the regulation according to the invention, which setpoint value profile brings about a minimization of the positive build-up and negative build-up on the rubber blanket of the transfer cylinder 11. Here, it is an empirically determined setpoint value profile. This empirically determined setpoint value profile is a function of one or more of a property of the printing material, a property of the printing plates and of the rubber blanket, a property of the damping solution used, and a property of the printed quality which is to be attained. Furthermore, the empirically determined setpoint value profile can be a function of a print-job amount and/or an ink coverage of the inking unit 25 which interacts with the damping unit 12 which is to be regulated. Here, an appropriate setpoint value profile can be provided in the storage device 17 for a large number of combinations of the above parameters. If there is no empirical setpoint value profile for the application of damping solution for a specific combination of process parameters in the storage device 17, then it is appropriate in terms of the present invention for a setpoint value profile to be determined arithmetically, for example, by interpolation from the stored setpoint value profiles of other parameter combinations for this parameter combination.

FIG. 2 shows a possible setpoint value profile which is made available in the storage device 17 for the regulation of the application of damping solution. The time is plotted on the horizontally extending axis 19, and the amount of damping solution applied is plotted on the vertically extending axis 20. For the setpoint value profile according to FIG. 2, an initial value and an end value of the amount of damping solution which is to be applied are predefined in the storage device 17, the application of damping solution being increased continuously between the initial value and the end value. As an alternative, it is also conceivable to increase the amount of damping solution which is applied discontinuously in steps between the initial value and the end value. The initial value for the application of damping solution, the end value for the application of damping solution and the rule for the increase in the application of damping solution between the initial value and the end value are dependent on the process parameters, such as a printing-material property and/or a printing-plate property and/or a damping-solution property and/or a rubber-blanket property and/or a printed quality and/or a print-job amount, and also optionally on further parameters.

Other setpoint values can also be predefined as a function of the current combination of parameters. Thus, for example, a setpoint value is conceivable which, starting from an initial value, provides an intermediate reduction and a subsequent rise in the amount of damping solution which is to be applied.

By way of the present invention, it is possible to minimize what is known as the positive build-up and the negative build-up on a rubber blanket by regulated application of damping solution to the printing plates of a forme cylinder, and thus to postpone the instant at which the rubber blanket has to be washed. It goes without saying that the empirically determined setpoint value profiles for the application of damping solution are of such a nature that the printed quality is not impaired by the application of damping solution.

The regulating method according to the invention for the application of damping solution can be coupled with an ink regulating system within the context of the present invention. It thus lies within the context of the present invention to supply the setpoint value profile and the prevailing actual value profile of the application of damping solution on the forme cylinder to an ink regulating system, in order that the ink regulating system can counteract any changes in the ink density which might occur. Here, a combination of this type of the regulation of the damping solution and the regulation of the ink takes into consideration both the desired ink density on the printed product and the desired minimization of the negative build-up or positive build-up on the rubber blanket. As a result of this, it is possible to fully utilize the maximum range of the parameters which are optimum in terms of printing technology.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating a printing press comprising a transfer cylinder, having a rubber blanket, and a forme cylinder, having a printing plate, the method comprising the steps of:
applying a damping solution to the printing plate of the forme cylinder; and
controlling an amount of the damping solution applied to the forme cylinder.

2. The method of claim 1, wherein the controlling of application of the damping solution comprises:
measuring the amount of the damping solution applied to the forme cylinder;
making a comparison between the measured amount of the damping solution and a setpoint value; and
modifying the amount of damping solution applied to the printing plate of the forme cylinder based upon the comparison.

3. The method of claim 2, wherein a setpoint value profile of the setpoint value is empirically determined.

4. The method of claim 3, wherein the setpoint value profile is empirically determined based on one or more of:
a property of the printing material;
a property of the printing plate of the forme cylinder; and
a property of the printing material and the properties of the rubber blanket.

5. The method of claim 4, wherein the setpoint value profile is empirically determined based on one or both:
a print quality of a print-job, and
a volume of the print-job.

6. The method of claim 3, wherein the setpoint value profile is determined based on a property of the damping solution.

7. The method of claim 3, wherein the setpoint value is determined based on ink coverage applied by an inking unit to the transfer cylinder or the forme cylinder.

8. A printing unit of a printing press comprising:
a transfer cylinder provided with a rubber blanket;
a forme cylinder provided with a printer plate engageable with the rubber blanket of the transfer cylinder;
an ink unit operable to apply ink to at least one of the transfer and forme cylinders;
a damping unit operable to apply damping solution to the forme cylinder; and
a control unit operative to control application of the damping solution by the damping unit to the forme cylinder.

9. The printing unit of claim 8, further comprising at least one sensor operable to measure an amount of the damping solution applied to the forme cylinder and to generate an output signal received by the control unit, the control unit being operative to make a comparison between received output signal and a setpoint value corresponding to a desired amount of applied damping solution and, based on the comparison, modifying the amount of damping solution being applied by the damping unit.

10. The printing unit of claim 9, wherein the sensor is a contactless sensor.

11. The printing unit of claim 8, wherein the control unit further comprises a storage device operable to store the setpoint value.

12. The printing unit of claim 9, wherein the sensor is operable to measure the amount of the damping solution applied to the forme cylinder.
